(19) United States
(12) Patent Application Publication
(10) Pub. No.: US 2018/0354609 A1
(43) Pub. Date: Dec. 13, 2018

(54) Aircraft with linear thruster arrangement

(71) Applicant: Joseph R. Renteria, Beaumont, CA (US)

(72) Inventor: Joseph R. Renteria, Beaumont, CA (US)

(21) Appl. No.: 15/861,479

(22) Filed: Jan. 3, 2018

Related U.S. Application Data
(60) Provisional application No. 62/516,361, filed on Jun. 7, 2017.

(51) Int. Cl. B64C 11/46; B64C 27/08; B64C 39/02; G05D 1/08; G05D 1/10

(52) U.S. Cl. CPC B64C 11/46; B64C 27/08; B64C 27/32; G05D 1/0858; G05D 1/102; B64C 39/024

(57) ABSTRACT

A linear thruster aircraft includes, an aircraft body; an air craft control unit with a processor, a non-transitory memory, and an input/output component; and at least one linear thruster arrangement with at least four thrusters mounted along at least one elongated axis of the aircraft body, such that the thrusters are configured to provide lift, pitch, roll, and yaw movement. Optionally, the linear thruster arrangement can include an alternating lateral offset of the thrusters from the elongated axis.

### CROSS-REFERENCE TO RELATED APPLICATIONS

This application claims the benefit of U.S. Provisional Application No. 62/516,361, filed Jun. 7, 2017, which is hereby included herein by reference in its entirety.

### FIELD OF THE INVENTION

The present invention relates generally to the field of aircraft thruster designs, and more particularly to methods and systems for arranging thrusters in a linear array.

### BACKGROUND OF THE INVENTION

In the world of aviation there are many different types of vertical take-off and landing (VTOL) systems, which provide a useful means of lifting personnel and payloads to perform various tasks. There have been many attempts at designing such systems in ways that maximize their portability and versatility by minimizing the footprint of the system. Unfortunately, these attempts always compromise on efficiency, stability, simplicity or make compromises on the original objective of having a small form factor. Usually such designs are complex and generally unsuccessful.

Helicopters are typically large and ungainly, with exposed rotors prevent them from being used in many applications, and are generally associated with very high maintenance costs. Small ducted fans are very inefficient in generating static thrust for lift, and provide poor stability when confined to a small footprint. Related industries have shown interest in small and compact vertical lift systems which are stable and safe to be around, but attempts to implement such designs have failed in the market.

As such, considering the foregoing, it may be appreciated that there continues to be a need for novel and improved devices and methods for vertical take-off and landing systems and devices.

### SUMMARY OF THE INVENTION

The foregoing needs are met, to a great extent, by the present invention, wherein in aspects of this invention, enhancements are provided to the existing models for vertical take-off and landing aircraft.

In an aspect, a linear thruster aircraft can include:
a) at least one linear thruster arrangement, including:
   a first thruster;
   a second thruster;
   a third thruster; and
   a fourth thruster; and
b) an aircraft body;
   wherein each thruster of the at least one linear thruster arrangement is connected to the aircraft body along an elongated axis of the aircraft body;
   wherein the at least one linear thruster arrangement is vertically displaced from a center of mass of the linear thruster aircraft;
   wherein the first and second thrusters are positioned on a first side of the center of mass of the linear thruster aircraft;
   wherein the third and fourth thrusters are positioned on a second side of the center of mass of the linear thruster aircraft.

In a related aspect, the linear thruster aircraft can be configured such that:
a) the first and second thrusters include at least one thruster configured to provide a first sideward downward thrust with respect to the elongated axis and at least one thruster configured to provide a second sideward downward thrust with respect to the elongated axis; and
b) the third and second thrusters include at least one thruster configured to provide a first sideward downward thrust with respect to the elongated axis and at least one thruster configured to provide a second sideward downward thrust with respect to the elongated axis;
whereby the at least one linear thruster arrangement is configured to provide lift, pitch, roll, and yaw for the linear thruster aircraft.

In yet a related aspect, each thruster of the first linear thruster arrangement can be mounted along a longitudinal axis of the aircraft body.

In another related aspect, each thruster of the first linear thruster arrangement can be mounted along a lateral axis of the aircraft body.

In yet another related aspect, each thruster of the first linear thruster arrangement can be a rotor.

In a related aspect, the first linear thruster arrangement can be positioned above a center of mass of the linear thruster aircraft, such that the first linear thruster arrangement lifts the linear thruster aircraft from a top of the linear thruster aircraft.

In a related aspect, the first linear thruster arrangement can be positioned below a center of mass of the linear thruster aircraft, such that the linear thruster arrangement lifts the linear thruster aircraft from a bottom of the linear thruster aircraft.

In a related aspect, the linear thruster aircraft can further include a plurality of rotor shrouds, wherein each thruster of the first linear thruster arrangement is configured to spin inside a rotor shroud.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a linear thruster aircraft, wherein the thrusters are located above the center of mass of the aircraft, according to an embodiment of the invention.

FIG. 2 is a perspective view of a linear thruster aircraft, wherein the thrusters are located below the center of mass of the aircraft, according to an embodiment of the invention.

FIG. 3 is a front view of a linear thruster aircraft, according to an embodiment of the invention.

FIG. 4 is a side view of a linear thruster aircraft, according to an embodiment of the invention.

FIG. 5A is a top view of a linear thruster aircraft, wherein the thrusters are located below the center of mass of the aircraft, according to an embodiment of the invention.

FIG. 5B is a top view of a linear thruster aircraft, wherein the thrusters have a lateral offset and are located below the center of mass of the aircraft, according to an embodiment of the invention.

FIG. 6A is a top view of a linear thruster aircraft, wherein surfaces are used to deflect the air moved by thrusters in order to create lateral forces needed to rotate the aircraft around the center of mass, according to an embodiment of the invention.

FIG. 6B is a front view of a thruster with rightward oriented control vanes, according to an embodiment of the invention.

FIG. 6C is a front view of a thruster with leftward oriented control vanes, according to an embodiment of the invention.

FIG. 6D is a perspective view of a thruster with leftward oriented control vanes, according to an embodiment of the invention.

FIG. 7 is a perspective view of a linear thruster aircraft, wherein the thrusters are located above the center of mass of the aircraft and are configured in an overlapping arrangement, according to an embodiment of the invention.

FIG. 8 is a perspective view of a linear thruster aircraft, wherein shrouds are used to house the thrusters which are spinning rotors, according to an embodiment of the invention.

FIG. 9A is a perspective view of a linear thruster aircraft, wherein the thrusters are located above and below the center of mass of the aircraft, according to an embodiment of the invention.

FIG. 9B is a perspective view of a linear thruster aircraft including a linear thruster arrangement with more than four thrusters, according to an embodiment of the invention.

FIG. 10A is a perspective view of a linear thruster aircraft with a thruster configuration, wherein thrusters are rotors which are angled to create a lateral force, according to an embodiment of the invention.

FIG. 10B is a side view of a linear thruster aircraft with a thruster configuration, wherein thrusters are rotors which are angled to create a lateral force, according to an embodiment of the invention.

FIG. 11 is a perspective view of a linear thruster aircraft, wherein multiple longitudinal rows of thrusters are used, wherein thrusters are angled to create a lateral force, according to an embodiment of the invention.

FIG. 12 is a perspective view of a thruster configuration, wherein thrusters are rotors contained within shrouds, and surfaces deflect air to create lateral forces, according to an embodiment of the invention.

FIG. 13 is a perspective view of a linear thruster aircraft, wherein thrusters are rotors which are angled to create some amount of lateral force wherein the thrusters are located below an aircraft body and the center of mass, according to an embodiment of the invention.

FIG. 14 is a perspective view of a linear thruster aircraft, wherein thrusters are rotors which are angled to create an anhedral effect to create some amount of lateral force and are arranged in rows, wherein the thrusters are located below an aircraft body and the center of mass, according to an embodiment of the invention.

FIG. 15 is a perspective view of a linear thruster aircraft, wherein thrusters are rotors which are angled to create a dihedral effect and to create some amount of lateral force, and are arranged in rows, wherein the thrusters are located below an aircraft body and the center of mass, according to an embodiment of the invention.

FIG. 16 is a perspective view of a linear thruster aircraft, wherein thrusters are rotors that are arranged in a linear array, which runs along a lateral axis of the aircraft, according to an embodiment of the invention.

FIG. 17 is a schematic diagram illustrating a linear thruster system, according to an embodiment of the invention.

FIG. 18 is a schematic diagram illustrating an aircraft control unit, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

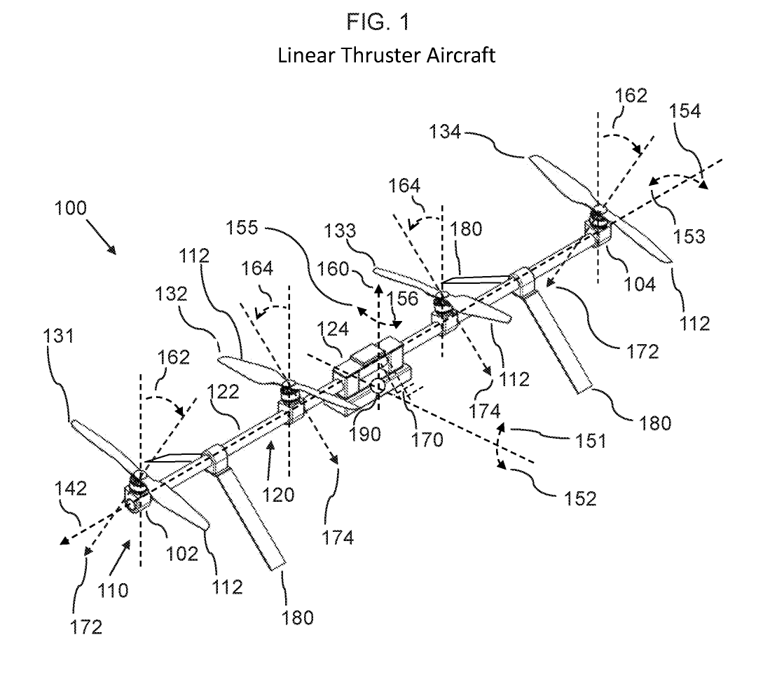

In the following, we describe the structure of an embodiment of a linear thruster aircraft 100 with reference to FIG. 1, in such manner that like reference numerals refer to like components throughout; a convention that we shall employ for the remainder of this specification.

In related embodiments, a linear thruster aircraft 100 includes a linear thruster arrangement 110, which is able to provide lift to an aircraft 100, while also providing pitch, roll and yaw stability. The linear thruster arrangement 110 is advantageous in that it can be configured to have an absolute minimal width or length because it allows the thrusters to be arranged in a linear or longitudinal fashion.

In various embodiments, a linear thruster aircraft 100, which can also be referred to as a linear thruster vehicle 100, can include all types of flying devices 100, including airplanes 100, and remote-controlled drones 100, but in some embodiments can include other types of vehicles 100, that may benefit from a linear thruster arrangement 110, such as for example remote-controlled power boats 100, cars 100, submersibles 100, such as a drone submarine with inline rotors along the top, etc. Various other embodiments can include flying devices that may benefit from having a linear thruster arrangement 110, such as novelty flying devices, including flying fish, arrows, hoverboards and other unique configurations.

In various embodiments, the linear thruster arrangement 110 can include a plurality of thrusters 112 that can be arranged along the longitudinal 142 or lateral axis 1644 of an aircraft 100, as shown in FIGS. 1 and 16, respectively. The thrusters 112 can be arranged in a longitudinal configuration, and so have a longitudinal axis along which the thruster configuration 110 runs, and which the thruster configuration 110 and connected aircraft body 120 must be stabilized around. The thrusters 112 provide lift to the aircraft 100 and are located above and/or below the center of mass of the aircraft 100. Some of the thrusters may be mounted at angles or use deflecting surfaces to produce some amount of lateral and/or longitudinal force. This allows the thrusters 112 to rotate the aircraft 100 around a longitudinal axis 142 and the center of mass 190, allowing a flight control system to provide pitch, roll and yaw stability.

In related embodiments, the linear thruster aircraft 100 can be configured with landing gear 180, landing legs 180, or other type of devices 180 to allow the aircraft 100 to be stably landed or stably positioned on a ground surface.

In related embodiments, the thrusters 112 can be turbines, propellers, or rotors, or other forms of propulsion mechanisms that generates thrust.

In related embodiments, the thrusters 112 may be powered by electric power, such that each thruster includes an electric engine, which receives electric power from at least one electric power source, such as a battery. However, in alternative embodiments, mechanical power may be transferred to each thruster, via axles, chain, or belt mechanical transfer, from at least one engine, such as an electrical or combustion engine.

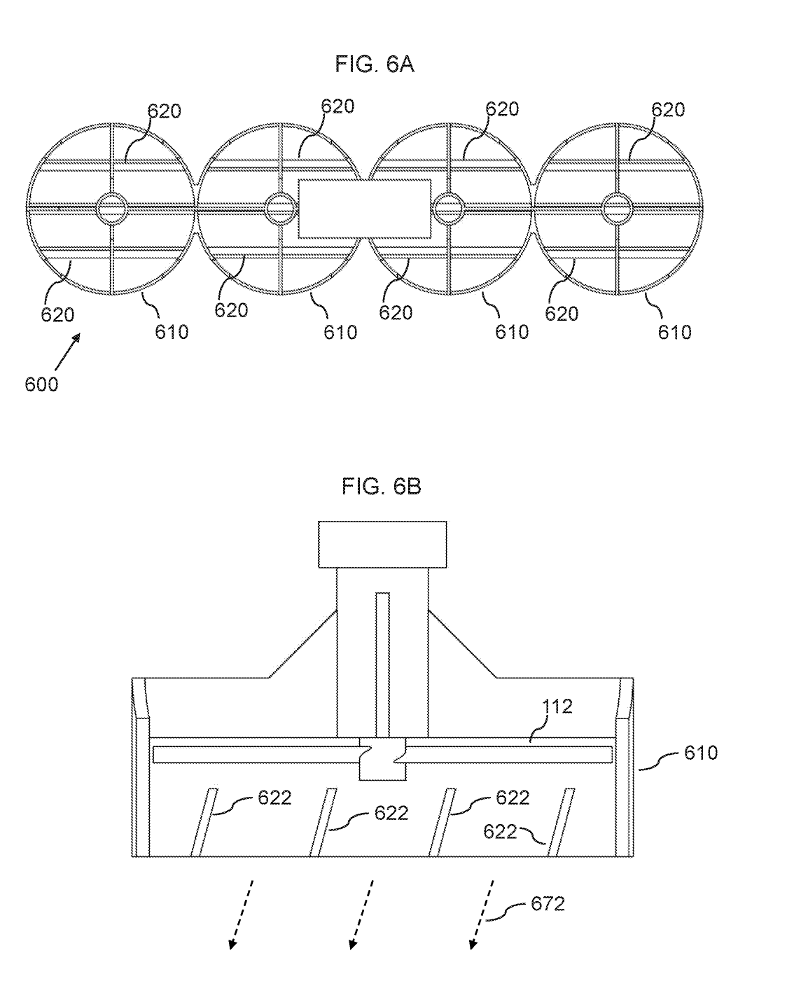

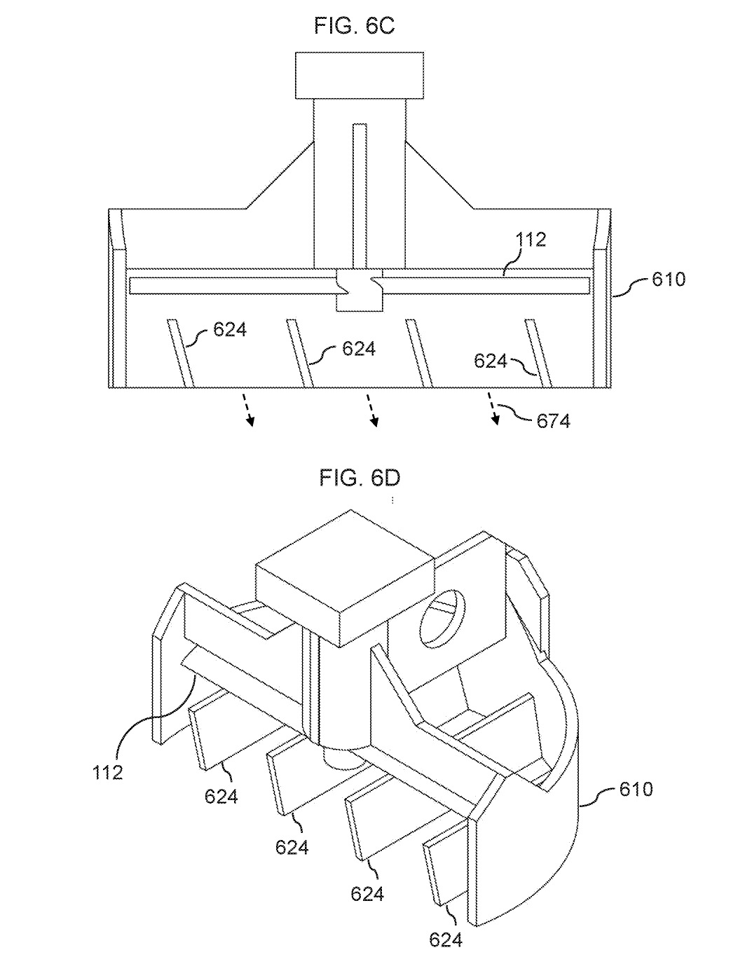

In related embodiments, some or all thrusters 112 can create an amount of lateral force so as to stabilize the aircraft around the longitudinal thruster configuration axis 142. This can be achieved by mounting thrusters at angles, by deflecting an airstream created by the thrusters with surfaces, or by other methods and devices. Thrusters 112 and/or deflection surfaces 620, as shown in FIGS. 6A and 6B, may be actively positioned to augment, enhance or fine tune control of aircrafts 100.

In some embodiments, it may be desirable to control or augment the control of yaw maneuvers with active control vanes 620. One such case is that where the thrusters are spinning rotors and an uneven number of rotors are used, such as for example three rotors. By using active control vanes, a designer is free to decouple rotor torque from the yaw stability of the aircraft 100.

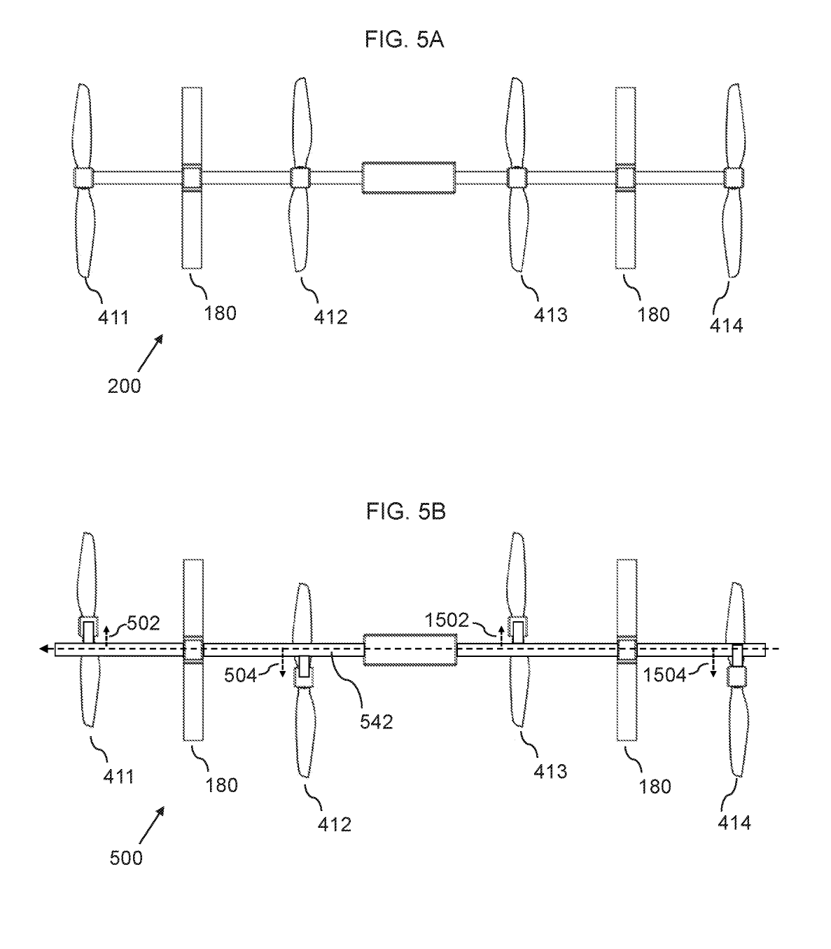

In some related embodiments, as shown in FIG. 5B, while the goal is to mount the thrusters 112 in a completely linear configuration, in order to produce the most compact aircraft 500 possible, it may also be desirable to configure the thrusters 112 in a substantially linear configuration, with a lateral offset 1502 1504 of the thrusters from the elongated axis 542 of the thruster configuration 110, which can add stability as well as allow a more compact longitudinal dimension. The lateral offset 502 504, can be a right side lateral offset 502 or a left side lateral offset 504, such that the thrusters 112 can be configured with alternating right and left side lateral offsets 502 504. Such a configuration allows the aircraft 500 to have some added stability based on the lateral distance between thrusters 112, similar to a conventional multirotor.

In other related embodiments, some or all of the thrusters 112 may be pivotally mounted, allowing an angle of the thruster to be actively or manually adjusted. Thrusters 112 may be rotors, where the angle of the thruster allows the thruster to provide yaw control to the aircraft and the rotor torque assists the thrust vector in yaw control.

In related embodiments, the purpose of the thrusters 112 being able to produce lateral forces is to allow the thrusters 112 to rotate an aircraft around the roll or pitch axis, depending on how the aircraft 100 is configured in relation to the thruster arrangement 110. This way, the thrusters 112 are able to provide stability to an aircraft 100 by rotating the aircraft 100, and the collective lifting thrust vector of the aircraft around an axis. Most multi-thruster aircrafts such as multirotors stabilize themselves by rotating the aircraft around multiple axis by producing varied vertical forces for different sections of the aircraft. While the various embodiments of the linear thruster aircraft 100 may also do this to some extent, a main stabilizing factor for the thruster configuration 100 around the longitudinal axis 142 is the lateral movements produced, which then rotate the thruster arrangement 110 around the longitudinal axis 142.

In related embodiments, to lift an aircraft 100, power is supplied to the thrusters 112. Differential thrust levels between the thrusters 112 then provides roll, pitch and yaw control. Thrusters 112 may have redundancy, allowing continued use and control of an aircraft even after one or more thrusters have failed. Increased differential thrust applied to a first plurality of thrusters 112, shall be understood to mean that relatively more thrust/power is applied to the first plurality of thrusters 112, relative to a second plurality of thrusters 112. Increased differential thrust applied to a first thruster 112, shall be understood to mean that relatively more thrust/power is applied to the first thruster 112, relative to a second thruster or other plurality of thrusters 112.

In various related embodiments, this unique thruster configuration 110 enables a designer to create VTOL aircraft which are as compact as possible along the longitudinal or lateral axis depending on the configuration. The thruster configuration 110 can be used for designing compact drones, flying cars, hoverbikes, hoverboards, jetpacks, personal air aircrafts and a variety of other configurations, including novelty configurations, such as fish or other animals, arrows, etc.

In a related embodiment, as shown in FIG. 1, a linear thruster aircraft 100 can include at least four thrusters 112 arranged in a linear array/thruster arrangement 110, which runs along the longitudinal axis 142 of an aircraft. In this embodiment, the thrusters 112 can be placed above the center of mass, and thereby lift the aircraft 100 from the top.

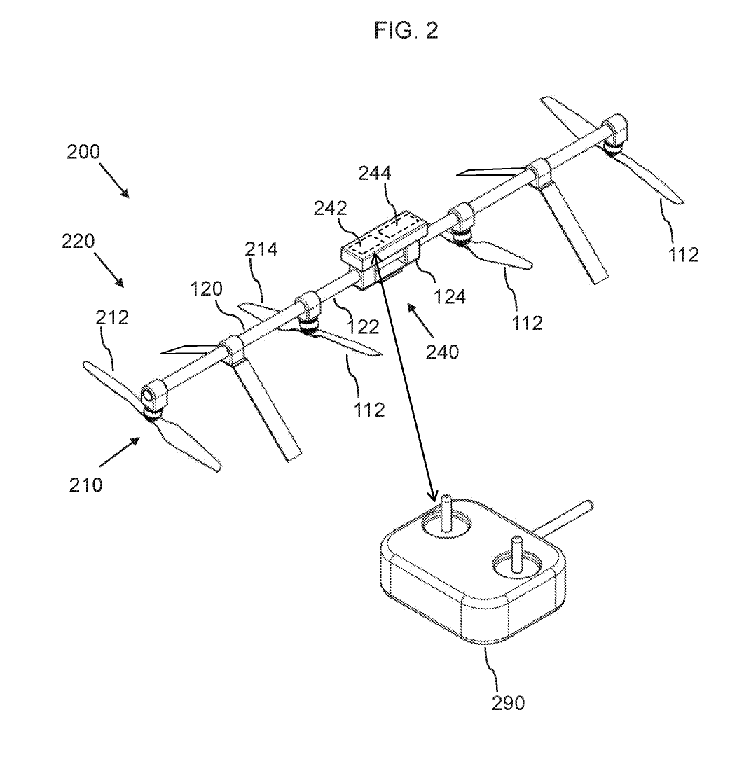

In a related embodiment, as shown in FIG. 2, a linear thruster aircraft 200 can include at least four thrusters 112 arranged in a linear array 210, which runs along the longitudinal axis 142 of an aircraft 100. In this embodiment, the thrusters can be placed below the center of mass, and thereby lift the aircraft 200 from the bottom.

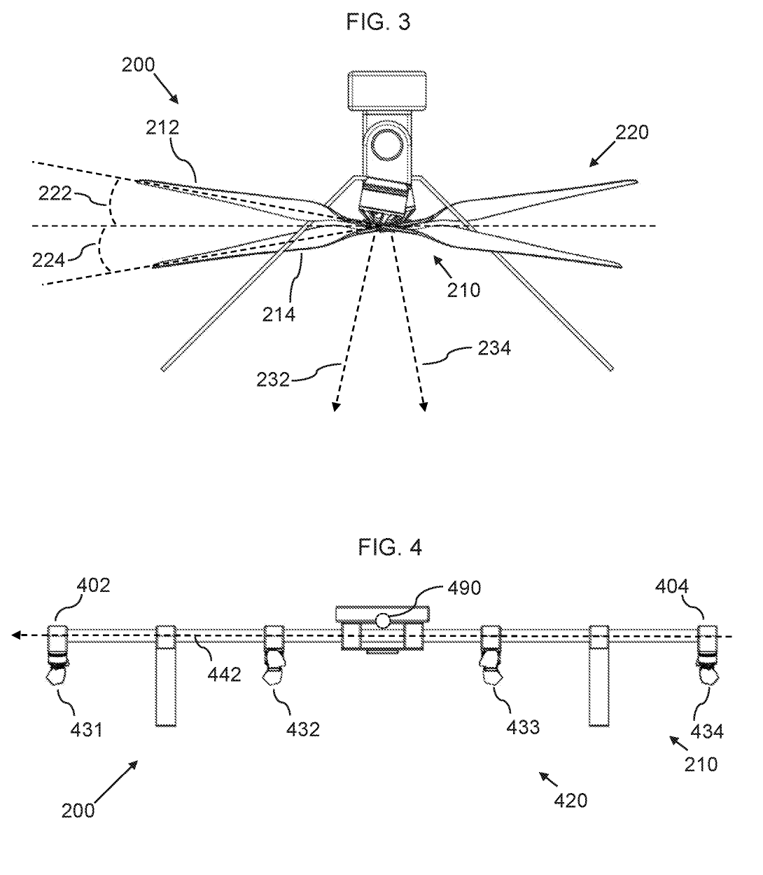

In a related embodiment, as shown in FIGS. 2 and 3, one or more thrusters 112 can be arranged in a linear array 210. One or more thrusters 112 can be laterally angled to produce a thrust vector 232 234 which produces some amount of force along the lateral axis of the thruster arrangement. This lateral force allows the thruster arrangement 110 to provide stability and control by rotating the aircraft around the center of mass. Thrusters 112 which run along the longitudinal axis 142 of the thruster arrangement 110 provide control around the longitudinal axis of the thruster arrangement. Opposing thrusters from across the lateral axis of the thruster arrangement provide pitch control. While the aircraft 100 200 is hovering, the lateral forces cancel each other out. Yaw control is provided through differential thrust between thrusters with opposing lateral forces and/or rotor torque in the case that the thrusters are rotors.

In a related embodiment, as shown in FIGS. 2 and 3, a thruster pair 220 can include:
a) a first thruster 212, which is mounted at a left lateral angle 222 relative to the longitudinal axis 142, to produce a left thrust vector 232; and
b) a second thruster 214, which is mounted at a right lateral angle 224 relative to the longitudinal axis 142, to produce a right thrust vector 234;
wherein the first and second thrusters 212 214 are left-right symmetrically mounted, with opposing left and right lateral angles 222 224;
wherein, as shown, the linear thruster aircraft 100 can include at least two thruster pairs 220 mounted front and rear along the longitudinal axis 142.

In a further related embodiment, the front and rear order of the first and second thrusters 212 214 can be reversed, such that a first thruster 212 can be configured with a right lateral angle, and a second thruster 214 can be configured with a left lateral angle.

In a related embodiment, as shown in FIG. 1, the linear thruster aircraft 100 can be configured such that the thrusters 112 lift the aircraft 100 from the top and are placed above the center of mass 190. The first thruster 131 can be positioned at a front 102 of the aircraft 100, and the fourth thruster 134 can be positioned at a rear 104 of the aircraft 100;

wherein each thruster 131 132 133 134 of the first linear thruster arrangement 110 is mounted along a longitudinal axis 142 of the aircraft body, sequentially from the front 102 to the rear 104;
wherein the first and fourth thrusters 131 134 are configured with a leftward tilt 162, such that the first and fourth thrusters 131 134 provide a (i.e. is configured with a) rightward downward thrust 172; and
wherein the second and third thrusters 132 133 are configured with a rightward tilt 164, such that the first and fourth thrusters 131 134 provide a (i.e. is configured with a) leftward downward thrust 174; such that:
a) The first and second thrusters 131 132 are configured to provide positive pitch 151 of the linear thruster aircraft 100, when increased differential thrust is applied to the first and second thrusters 131 132;
b) The third and fourth thrusters 133 134 are configured to provide negative pitch 152 of the linear thruster aircraft 100, when increased differential thrust is applied to the third and fourth thrusters 133 134;
c) The second and third thrusters 132 133 are configured to provide right roll 153 of the linear thruster aircraft 100, when increased differential thrust is applied to the second and third thrusters 132 133;
d) The first and fourth thrusters 131 134 are configured to provide left roll 154 of the linear thruster aircraft 100, when increased differential thrust is applied to the first and fourth thrusters 131 134;
e) The second and fourth thrusters 132 134 are configured to provide right yaw 155 of the linear thruster aircraft 100, when increased differential thrust is applied to the second and fourth thrusters 132 134; and
f) The first and third thrusters 131 133 are configured to provide left yaw 156 of the linear thruster aircraft 100, when increased differential thrust is applied to the first and third thrusters 131 133.

In a related embodiment, as shown in FIG. 4, the linear thruster aircraft 200 can be configured such that the thrusters lift the aircraft 200 from the bottom and are placed below the center of mass 490. The first thruster 431 can be positioned at a front 402 of the aircraft 200, and the fourth thruster can be positioned at a rear 404 of the aircraft 200;

wherein each thruster 431 432 433 434 of the first linear thruster arrangement 210 is mounted along a longitudinal axis 442 of the aircraft body;
wherein the first and fourth thrusters 431 434 are configured with a rightward tilt 162, such that the first and fourth thrusters 431 434 provide a rightward downward thrust 172; and
wherein the second and third thrusters 432 433 are configured with a leftward tilt 164, such that the first and fourth thrusters 431 434 provide a leftward downward thrust 172; such that:
a) The first and second thrusters 431 432 are configured to provide positive pitch 151 of the linear thruster aircraft 200, when increased differential thrust is applied to the first and second thrusters 431 432;
b) The third and fourth thrusters 433 434 are configured to provide negative pitch 152 of the linear thruster aircraft 200, when increased differential thrust is applied to the third and fourth thrusters 433 434;
c) The first and fourth thrusters 431 434 are configured to provide right roll 153 of the linear thruster aircraft 200, when increased differential thrust is applied to the first and fourth thrusters 431 434;
d) The second and third thrusters 432 433 are configured to provide left roll 154 of the linear thruster aircraft 200, when increased differential thrust is applied to the second and third thrusters 432 433;
e) The second and fourth thrusters 432 434 are configured to provide right yaw 155 of the linear thruster aircraft 200, when increased differential thrust is applied to second and fourth thrusters 432 434; and
f) The first and third thrusters 431 433 are configured to provide left yaw 156 of the linear thruster aircraft 200, when increased differential thrust is applied to the first and third thrusters 431 433.

In a related embodiment, FIG. 5A shows a top view of the linear thruster aircraft 200.

In a related embodiment, as shown in FIG. 6A, a linear thruster aircraft 600 can be configured with thrusters 112 (not shown) that can be spinning rotors 112 (not shown), such that each rotor/thruster 112 can be configured to spin inside a rotor shroud 610, which is located above stationary control vanes 620, which redirect the downward flowing air to the lateral sides of the thruster arrangement 110 210. In this embodiment, the thrusters do not necessarily need to be mounted at angles since they can rely on the control vanes to create the necessary lateral forces.

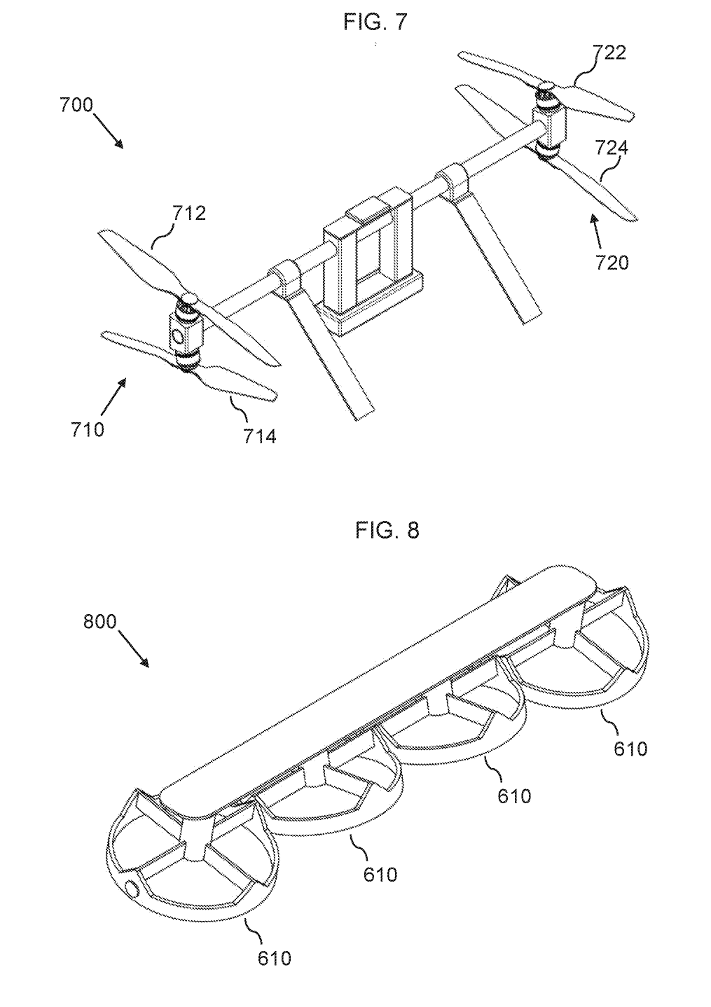

In a related embodiment, as shown in FIG. 7, a linear thruster aircraft 700 can be configured with thrusters 712 714 722 724 that can be spinning rotors, such that two front rotors 712 714 and two rear rotors 722 724 can be mounted fully overlapping, each fully overlapping mounted thruster pair 710 720 including a first/top thruster 712 722 and a second/bottom thruster 714 724, to save space and create a more compact unit. Thrusters 712 714 722 724 configured in this way can be angled to create some lateral forces, and may be located above and/or below the center of mass of the aircraft.

In a related embodiment, as shown in FIGS. 8 and 12, a linear thruster aircraft 800 1200 can be configured with thrusters 112 (not shown) that can be spinning rotors 112 (not shown) placed below the aircraft and below the center of mass, such that each rotor/thruster 112 can be configured to spin inside a rotor shroud 610 810. The thrusters are spinning rotors placed below the aircraft and below the center of mass. The rotors spin inside shrouds 610 810 to increase safety and can be angled to the lateral sides of the thruster arrangement and the aircraft in order to create the necessary lateral forces to provide roll stability.

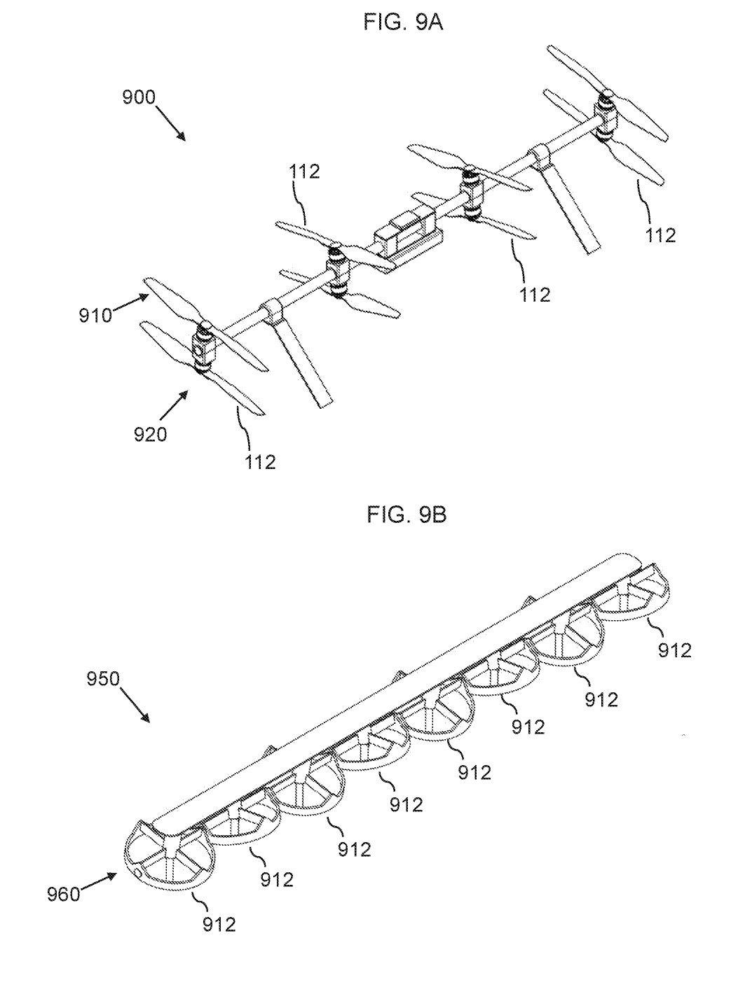

In a related embodiment, as shown in FIG. 9A, a linear thruster aircraft 900 can be configured with multiple thrusters 112 arranged in upper and lower longitudinal arrays 910 920, which run along the top and the bottom of the aircraft 900. The thrusters 112 can be spinning rotors placed above and below the aircraft and the center of mass of the aircraft. The rotors/thrusters 112 can be angled to the lateral sides of the thruster arrangement 910 920 and the aircraft 900 in order to create the necessary lateral forces to provide roll stability.

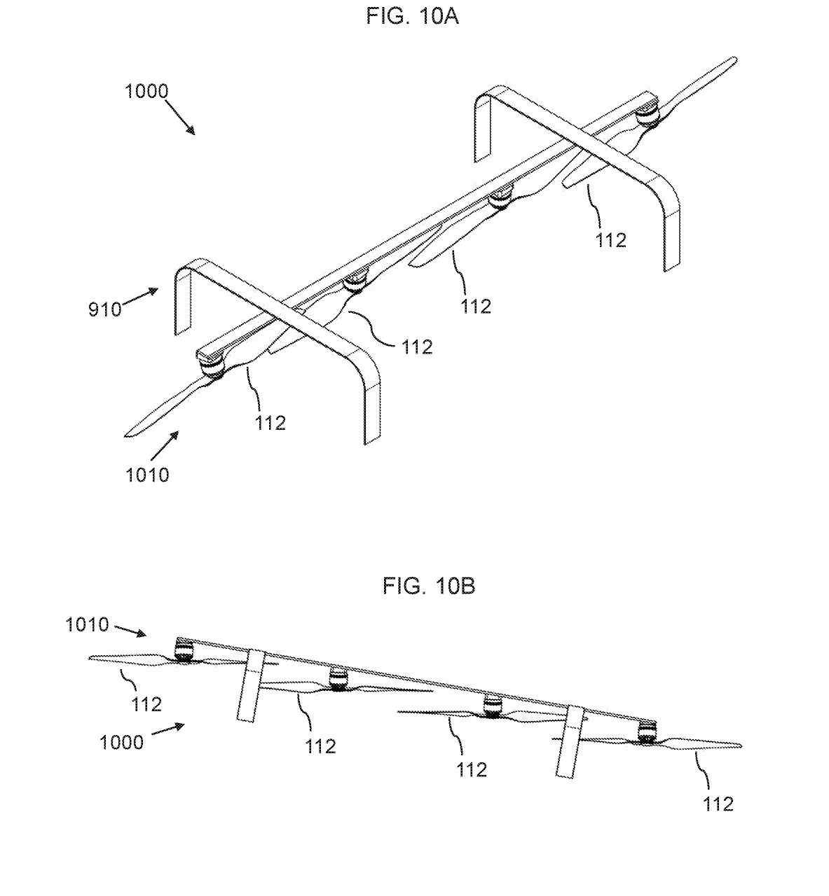

In a related embodiment, as shown in FIGS. 10A and 10B, a linear thruster aircraft 1000 can include a thruster assembly 1010, which can include at least four thrusters 112 arranged in a linear/longitudinal array 1010, which also runs (is positioned) along the longitudinal axis of an aircraft. In this arrangement, the thrusters can be spinning rotors 112 and may be mounted at angles and/or at varying heights in relation to each other, allowing the rotors to partially overlap, which allows the aircraft to have a smaller footprint.

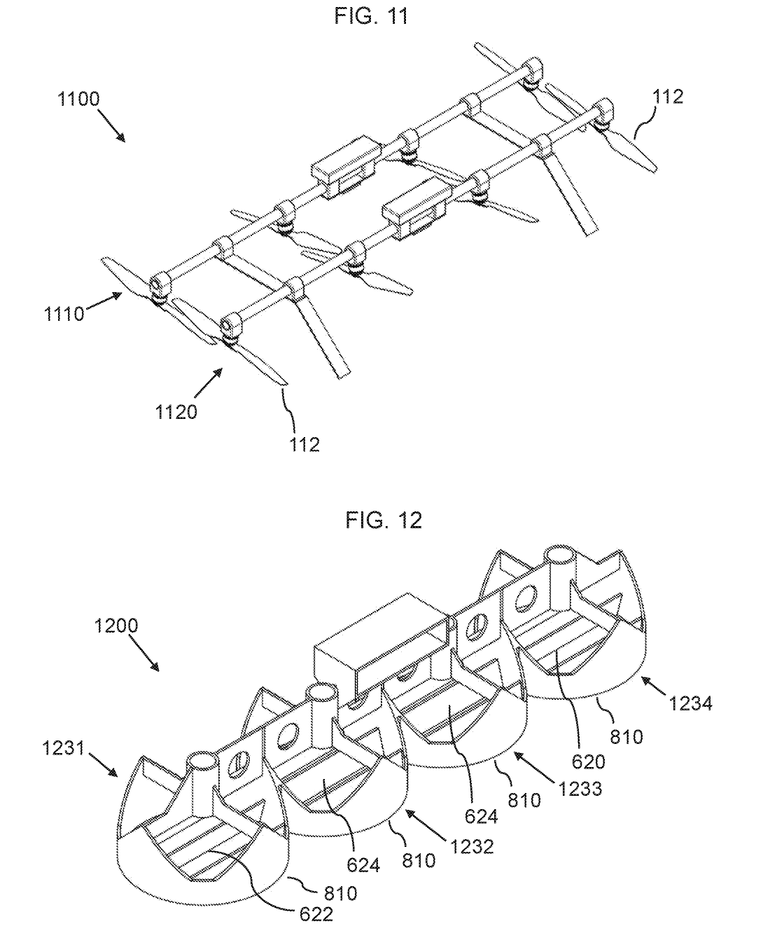

In a related embodiment, as shown in FIG. 11, a linear thruster aircraft 1100 can include at least two longitudinal thruster assemblies 1110 1120, wherein the thrusters 112 can be spinning rotors 112, which are mounted at angles to create the required lateral forces. The rotors 112 can overlap each other resulting in a more compact aircraft 1100, and can be located below the center of mass of the aircraft 1100 allowing them to provide roll stability.

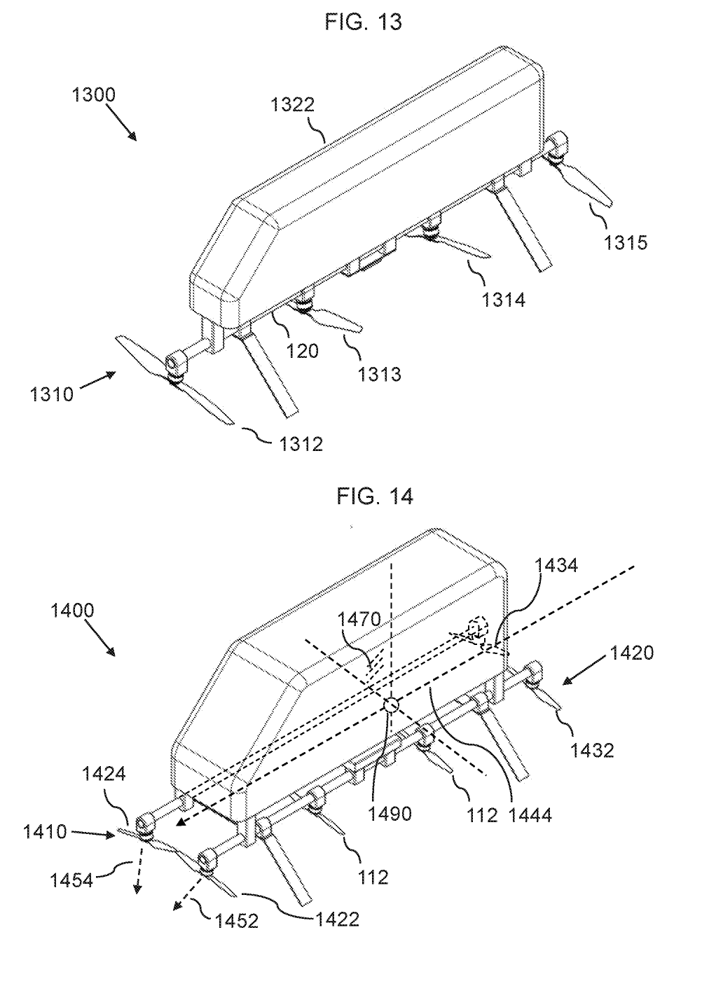

In a related embodiment, as shown in FIG. 13, a linear thruster aircraft 1300 can include at least four thrusters 1312 1313 1314 1315 arranged in a longitudinal array 1310. The thrusters 112 can be spinning rotors placed below the aircraft and below the center of mass. As shown, the thrusters can be located in such a way that airflow is not significantly impeded by the aircraft main body 1322 and the thrusters lift the aircraft from below while providing roll stability by producing lateral forces below the center of mass of the aircraft.

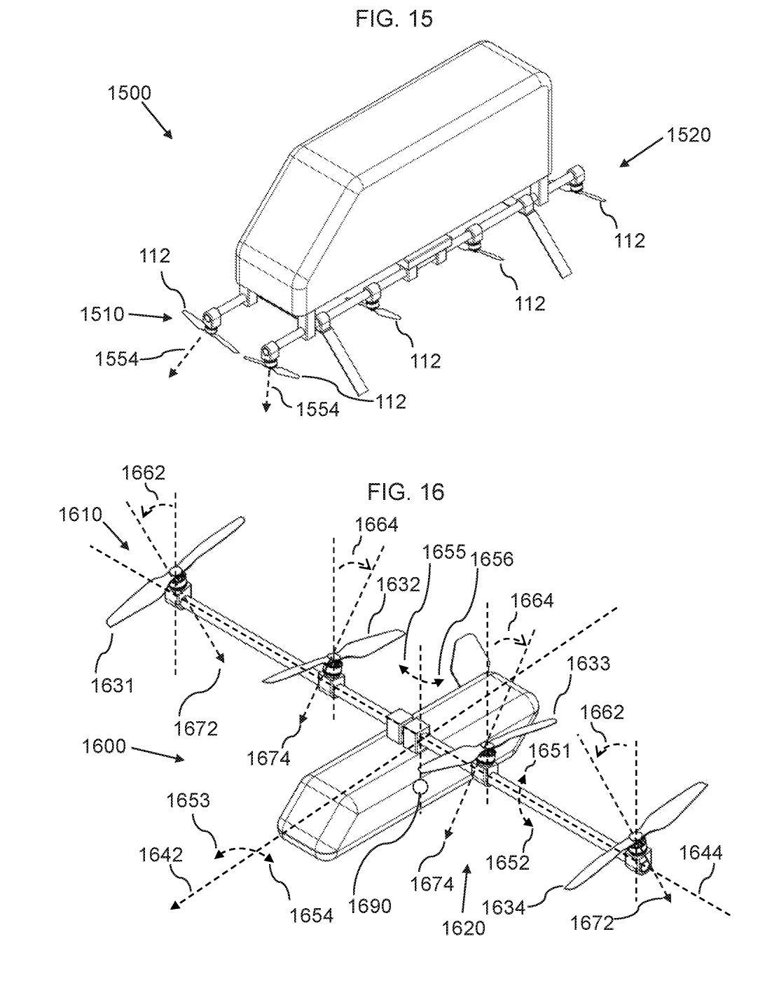

In a related embodiment, as shown in FIG. 14, a linear thruster aircraft 1400 can include at least two longitudinal arrangements 1410 1420 of thrusters 112 which also run along the longitudinal axis of an aircraft. The thrusters are spinning rotors placed below the aircraft and below the center of mass. The rotors are mounted at angles, such that they are able to produce the lateral forces needed to provide roll stability. While any combination of leftward, rightward and neutrally oriented thruster configurations may be able to provide the needed stability, this embodiment features an arrangement wherein the left and right thrusters 1410 1420 are configured to angle inwards, such that the left and right thrusters 1410 1420 are creating inward thrust vectors 1452 in relation to the aircraft, or as shown in FIG. 15, the left and right thrusters 1510 1520 can be configured to angle outwards, such that the left and right thrusters 1510 1520 create outward thrust vectors 1554 in relation to the aircraft 1500.

In a related embodiment, as shown in FIGS. 14 and 15, a linear thruster aircraft 1400 1500, can include:
a) At least one linear thruster arrangement, comprising a first linear thruster arrangement 1410 1510 and a second linear thruster arrangement 1420 1520, comprising
   a first plurality of at least two thrusters 1422 1424, which are positioned to a front/first side of a center of mass 1490 of the linear thruster aircraft 100, with respect to a perpendicular plane 1470 of the center of mass, which perpendicular plane 1470 is perpendicular to an elongated axis 1444 of the linear thruster aircraft; and
   a second plurality of at least two thrusters 1432 1434, which are positioned to a rear/second (i.e. opposite) side of the center of mass 190 of the linear thruster aircraft, with respect to the perpendicular plane 170 of the center mass;
wherein the first plurality comprises at least one thruster 1422 configured to provide a right/rear/first sideward downward thrust 1452 and at least one thruster 1424 configured to provide a left/front/opposite second sideward downward thrust 1454; and
wherein the second plurality comprises at least one thruster 1432 configured to provide a right/rear/first sideward downward thrust 1452 and at least one thruster 1434 (shown in dotted lines behind main body), configured to provide a left/front/opposite second downward thrust 1454;
whereby the first and second linear thruster arrangements 1410 1420 1520 1510 are configured to provide lift 160, pitch 151 152, roll 152 153, and yaw 155 156 for the linear thruster aircraft 1400 1500.

In a related embodiment, as shown in FIG. 16, a linear thruster aircraft 1600 can include at least four thrusters arranged in a linear array which is positioned along the lateral axis 1644 of the aircraft 1600, which is perpendicular to the longitudinal axis 1642. The thrusters are spinning rotors placed above the aircraft and above the center of mass of the aircraft. The thrusters are mounted at angles in order to provide the needed stability around the longitudinal axis 1642 of the thruster arrangement which is the lateral or pitch axis of the aircraft in this embodiment;

wherein the first and fourth thrusters 1631 1634 are configured with a forward tilt 1662, such that the first and fourth thrusters 1631 1634 provide a rearward downward thrust 1672; and the second and third thrusters 1632 1633 are configured with a rearward tilt 1664, such that the second and third thrusters 1632 1633 provide a forward downward thrust 1674; such that:
a) The second and third thrusters 1632 1633 are configured to provide positive pitch 1651 of the linear thruster aircraft 1600, when increased differential thrust is applied to the second and third thrusters 1632 1633;
b) The first and fourth thrusters 1631 1634 are configured to provide negative pitch 1652 of the linear thruster aircraft 1600, when increased differential thrust is applied to the first and fourth thrusters 1631 1634;
c) The third and fourth thrusters 1633 1634 are configured to provide right roll 1653 of the linear thruster aircraft 1600, when increased differential thrust is applied to the third and fourth thrusters 1633 1634;
d) The first and second thrusters 1631 1632 are configured to provide left roll 1654 of the linear thruster aircraft 1600, when increased differential thrust is applied to the first and second thrusters 1631 1632;
e) The second and fourth thrusters 1632 1634 are configured to provide right yaw 1655 of the linear thruster aircraft 1600, when increased differential thrust is applied to second and fourth thrusters 1632 1634; and
f) The first and third thrusters 1631 1633 are configured to provide left yaw 1656 of the linear thruster aircraft 1600, when increased differential thrust is applied to the first and third thrusters 1631 1633.

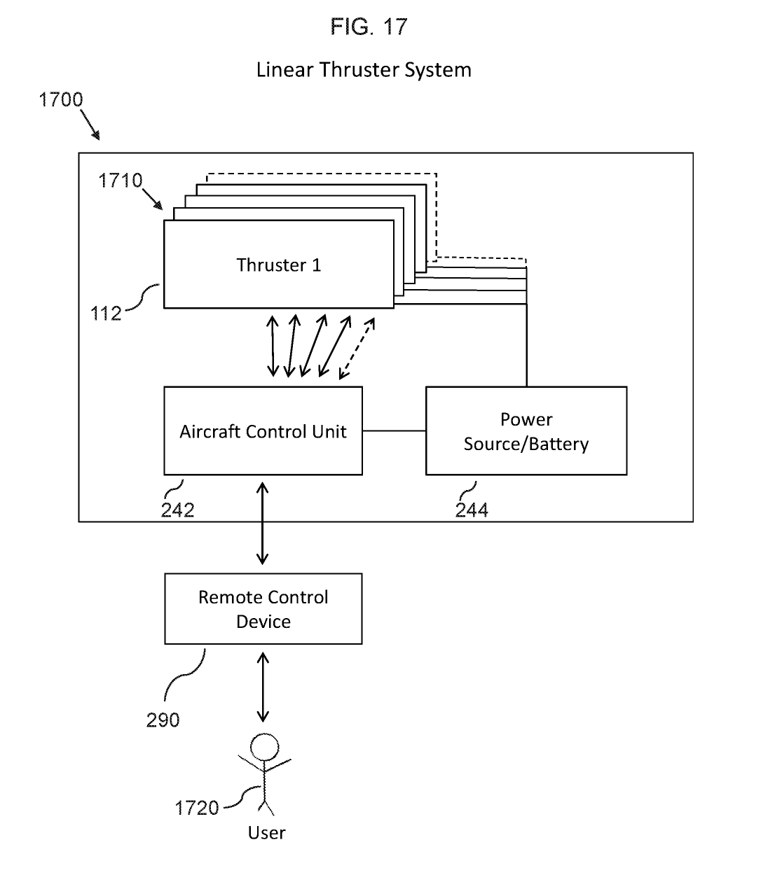

In an embodiment, as shown in FIG. 17, a linear thruster system 1700 can include:
a) a linear thruster arrangement 1710, including a plurality of thrusters 112;
b) a power source 244, such as a battery 244; and
c) an aircraft control unit 242, which can be mounted in a main body 122 of the aircraft 100;
wherein the aircraft control unit 242 is configured to control a specific power applied for each thruster 112 in the plurality of thrusters 112, wherein the specific power applied for each thruster is provided by the power source 244.

In a related embodiment, an aircraft control unit 242 can include:
a) A processor 1802;
b) A non-transitory memory 1804;
c) An input/output component 1806; and
d) A power manager 1810, which is configured to control the specific power applied for each thruster 112 in the plurality of thrusters 112; all connected via
e) A data bus 1820.

In an embodiment, as shown in FIGS. 1, 2, 5A, 5B, 7, 9A, 11, 13, 14, 15, and 16, a linear thruster aircraft 100 200 500 700 900 1100 1300 1400 1500 1600, can include:
a) a first linear thruster arrangement 110, including:
   a first thruster 112; and
   a second thruster 112;
   a third thruster 112; and
   a fourth thruster 112; and
b) an aircraft body 120, which can include:
   an elongated mounting nacelle 122; and
   a main body 124, which can include an aircraft control unit 242;
wherein each thruster of the first linear thruster arrangement 110 is connected to the aircraft body 120 along an elongated axis 142 1644 of the aircraft body, which can be along the elongated mounting nacelle, such that the elongated axis 142 1644 can for example be a lateral axis 1644 or a longitudinal axis 142 of the aircraft body 120;
wherein the first linear thruster arrangement is vertically displaced from the center of mass 190 of the linear thruster aircraft 100, such that the first linear thruster arrangement 110 is mounted either above or below the center of mass 190 490, as for example shown in respectively FIGS. 1 and 4;
wherein the first and second thrusters are positioned/mounted on a front/right/first side of the center of mass of the linear thruster aircraft, with respect to a perpendicular plane 170 of the center of mass, which perpendicular plane 170 is perpendicular to the elongated axis 144 1644 of the linear thruster aircraft;
wherein the third and fourth thrusters are positioned mounted behind/left/to a second (opposite) side of the center of mass of the linear thruster aircraft, with respect to the perpendicular plane 170 of the center mass.

In a related embodiment, as shown in FIG. 1, each thruster of the first linear thruster arrangement can be mounted along a longitudinal axis of the aircraft body.

In a related embodiment, as shown in FIG. 16, each thruster of the first linear thruster arrangement can be mounted along a lateral axis of the aircraft body.

In a related embodiment, as shown in FIG. 1, each thruster of the first linear thruster arrangement can be a rotor.

In a related embodiment, as shown in FIG. 1, the first linear thruster arrangement can be positioned above a center of mass of the linear thruster aircraft, such that the first linear thruster arrangement lifts the linear thruster aircraft from a top of the linear thruster aircraft.

In a related embodiment, as shown in FIG. 2, the first linear thruster arrangement can be positioned below a center of mass of the linear thruster aircraft, such that the linear thruster arrangement lifts the linear thruster aircraft from a bottom of the linear thruster aircraft.

In a related embodiment, as shown in FIGS. 6A, 6B, 6C, 6D, and 8, the linear thruster aircraft can further include a plurality of rotor shrouds, wherein each thruster 112 of the first linear thruster arrangement is configured to spin inside a rotor shroud.

In a related embodiment, as shown in FIG. 1, the linear thruster aircraft can be configured such that:
a) the first thruster is mounted at a left lateral angle relative to the elongated axis, such that the first thruster is configured to provide a leftward downward thrust; and
b) a second thruster is mounted at a right lateral angle relative to the elongated axis, such that the second thruster is configured to provide a rightward downward thrust.

In a related embodiment, as shown in FIG. 1,
wherein each thruster 112 of the first linear thruster arrangement 110 is mounted along a longitudinal axis of the aircraft body;
wherein the first linear thruster arrangement 110 is positioned above a center of mass 190 of the linear thruster aircraft;
wherein the first and fourth thrusters 131 134 are configured with a rightward downward thrust 172; and
wherein the second and third thrusters 132 133 are configured with a leftward downward thrust 174, such that:
   the first and second thrusters 131 132 are configured to provide a positive pitch 151 of the linear thruster aircraft 100, when a first increased differential thrust is applied to the first and second thrusters 131 132;
   the third and fourth thrusters 133 134 are configured to provide a negative pitch 152 of the linear thruster aircraft 100, when a second increased differential thrust is applied to the third and fourth thrusters 133 134;
   the second and third thrusters 132 133 are configured to provide a right roll 153 of the linear thruster aircraft 100, when a third increased differential thrust is applied to the second and third thrusters 132 133;
   the first and fourth thrusters 131 134 are configured to provide a left roll 154 of the linear thruster aircraft 100, when a fourth increased differential thrust is applied to the first and fourth thrusters 131 134;
   the second and fourth thrusters 132 134 are configured to provide a right yaw 155 of the linear thruster aircraft 100, when a fifth increased differential thrust is applied to the second and fourth thrusters 132 134; and
   the first and third thrusters 131 133 are configured to provide a left side yaw 156 of the linear thruster aircraft, when a sixth increased differential thrust is applied to the first and third thrusters 131 133.

In a related embodiment, it is readily apparent to an aircraft designer of ordinary skill in the art that the rightward-leftward order of thrusters 112 can be reversed, while the first linear thruster arrangement retains ability to provide lift, pitch, roll, and yaw for the linear thruster aircraft.

Thus, in a related embodiment, as shown in FIG. 1,
wherein each thruster 112 of the first linear thruster arrangement 110 is mounted along a longitudinal axis 142 of the aircraft body;
wherein the first linear thruster arrangement 110 is positioned above a center of mass 190 of the linear thruster aircraft;
wherein the first and fourth thrusters 131 134 are configured with a first sideward downward thrust 172 174 with respect to the longitudinal axis 142,
which can be a rightward downward thrust 172 or a leftward downward thrust 174; and
wherein the second and third thrusters 132 133 are configured with a second sideward downward thrust 172 174 with respect to the longitudinal axis, which can be respectively a leftward downward thrust 174 or a rightward downward thrust 172; such that:
   the first and second thrusters 131 132 are configured to provide a positive pitch 151 of the linear thruster aircraft 100, when a first increased differential thrust is applied to the first and second thrusters 131 132;
   the third and fourth thrusters 133 134 are configured to provide a negative pitch 152 of the linear thruster aircraft 100, when a second increased differential thrust is applied to the third and fourth thrusters 133 134;
   the second and third thrusters 132 133 are configured to provide a first side roll 153 154 of the linear thruster aircraft 100, when a third increased differential thrust is applied to the second and third thrusters 132 133;
   the first and fourth thrusters 131 134 are configured to provide a second side roll 154 153 of the linear thruster aircraft 100, when a fourth increased differential thrust is applied to the first and fourth thrusters 131 134;
   the second and fourth thrusters 132 134 are configured to provide a first side yaw 155 156 of the linear thruster aircraft 100, when a sixth increased differential thrust is applied to the second and fourth thrusters 132 134; and
   the first and third thrusters 131 133 are configured to provide a second side yaw 156 155 of the linear thruster aircraft, when a fifth increased differential thrust is applied to the first and third thrusters 131 133.

In a related embodiment, as shown in FIG. 1, the first linear thruster arrangement 110 can be positioned above a center of mass 190 of the linear thruster aircraft 100;

wherein the first and fourth thrusters are configured with a leftward tilt 162, and the second and third thrusters are configured with a rightward tilt 164.

In a related embodiment, as shown in FIGS. 6A, 6B, 6C, 6D, and 12, the linear thruster aircraft can further include a plurality of control vanes 620, wherein the first linear thruster arrangement can be positioned above a center of mass of the linear thruster aircraft;

wherein the first and fourth thrusters 1231 1234 can be configured with rightward oriented control vanes 622, and the second and third thrusters 1232 1233 can be configured with leftward oriented control vanes 624.

FIG. 6B shows a front view of rightward oriented control vanes 622, creating a rightward downward thrust 172.

FIG. 6C shows a front view of leftward oriented control vanes 624, creating a leftward downward thrust 174.

FIG. 6D shows a perspective view of leftward oriented control vanes 624, creating a leftward downward thrust 174.

In a related embodiment, as shown in FIG. 4, the first linear thruster arrangement 210 can be positioned below a center of mass 490 of the linear thruster aircraft 200;

wherein the first and fourth thrusters are configured with a leftward tilt 162, and the second and third thrusters are configured with a rightward tilt 164;
such that the right/first and left/second side roll is reversed compared to the linear thruster aircraft 100 with the first linear thruster arrangement 110 positioned above the center of mass 190.

Thus, in a related embodiment, as shown in FIGS. 3 and 4,
wherein each thruster 431 432 433 434 of the first linear thruster arrangement 410 is mounted along a longitudinal axis 442 of the aircraft body 420; wherein the first linear thruster arrangement 410 is positioned below a center of mass 190 of the linear thruster aircraft 200;
wherein the first and fourth thrusters 431 434 are configured with a first sideward downward thrust 172 174 with respect to the longitudinal axis 442, which can be a rightward downward thrust 172 or a leftward downward thrust 174; and
wherein the second and third thrusters 432 433 are configured with a second sideward downward thrust 172 174 with respect to the longitudinal axis, which can be respectively a leftward downward thrust 174 or a rightward downward thrust 172; such that:
   the first and second thrusters 431 432 are configured to provide a positive pitch 151 of the linear thruster aircraft 200, when a first increased differential thrust is applied to the first and second thrusters 431 432;
   the third and fourth thrusters 433 434 are configured to provide a negative pitch 152 of the linear thruster aircraft 200, when a second increased differential thrust is applied to the third and fourth thrusters 433 434;
   the first and fourth thrusters 431 434 are configured to provide a first side roll 153 154 of the linear thruster aircraft 200, when a third increased differential thrust is applied to the first and fourth thrusters 431 434;
   the second and third thrusters 432 433 are configured to provide a second side roll 154 153 of the linear thruster aircraft 200, when a fourth increased differential thrust is applied to the second and third thrusters 432 433;
   the second and fourth thrusters 432 434 are configured to provide a first side yaw 155 of the linear thruster aircraft 200, when a fifth increased differential thrust is applied to the second and fourth thrusters 132 134;
   the first and third thrusters 431 433 are configured to provide a second yaw 156 of the linear thruster aircraft 200, when a sixth increased differential thrust is applied to the first and third thrusters 431 433.

In a related embodiment, FIG. 16 shows a linear thruster aircraft 1600;
wherein each thruster 1631 1632 1633 1634 of the first linear thruster arrangement 1610 is mounted along a lateral axis 1644 of the aircraft body 1620;
wherein the first linear thruster arrangement 110 is positioned above a center of mass 1690 of the linear thruster aircraft 1600;
wherein the first and fourth thrusters 1631 1634 are configured with a rearward downward thrust 1672; and
wherein the second and third thrusters 1632 1633 are configured with a forward downward thrust 1674; such that:
   the second and third thrusters 1632 1633 are configured to provide a positive pitch 1651 of the linear thruster aircraft 1600, when a first increased differential thrust is applied to the second and third thrusters 1632 1633;
   the first and fourth thrusters 1631 1634 are configured to provide a negative pitch 1652 of the linear thruster aircraft 1600, when a second increased differential thrust is applied to the first and fourth thrusters 1631 1634;
   the third and fourth thrusters 1633 1634 are configured to provide a right roll 1653 of the linear thruster aircraft 1600, when a third increased differential thrust is applied to the third and fourth thrusters 1633 1634;
   the first and second thrusters 1631 1632 are configured to provide a left roll 1654 of the linear thruster aircraft 1600, when a fourth increased differential thrust is applied to the first and second thrusters 1631 1632;
   the second and fourth thrusters 1632 1634 are configured to provide a right yaw 1655 of the linear thruster aircraft, when a fifth increased differential thrust is applied to second and fourth thrusters 1632 1634; and
   the first and third thrusters 1631 1633 are configured to provide a left yaw 1656 of the linear thruster aircraft 1600, when a sixth increased differential thrust is applied to the first and third thrusters 1631 1633.

In a related embodiment, it is readily apparent to an aircraft designer of ordinary skill in the art that the front-rear order of thrusters 112 can be reversed, while the first linear thruster arrangement retains ability to provide lift, pitch, roll, and yaw for the linear thruster aircraft.

Thus, in a related embodiment, FIG. 16 shows a linear thruster aircraft 1600;
wherein each thruster 1631 1632 1633 1634 of the first linear thruster arrangement 1610 is mounted along a lateral axis 1644 of the aircraft body 1620;
wherein the first linear thruster arrangement 110 is positioned above a center of mass 1690 of the linear thruster aircraft 1600;
wherein the first and fourth thrusters 1631 1634 are configured with a first side downward thrust 1672 1674 with respect to the lateral axis 1644, which can be a rearward downward thrust 1672 or a frontward downward thrust 1674; and
wherein the second and third thrusters 1632 1633 are configured with a second side downward thrust 1674 1672 with respect to the lateral axis 1644, which can be respectively a frontward downward thrust 1674 or a rearward downward thrust 1672; such that:
   the second and third thrusters 1632 1633 are configured to provide a first vertical direction pitch 1651 1652 of the linear thruster aircraft 1600, when a first increased differential thrust is applied to the second and third thrusters 1632 1633;
   the first and fourth thrusters 1631 1634 are configured to provide a second vertical direction pitch 1652 1651 of the linear thruster aircraft 1600, when a second increased differential thrust is applied to the first and fourth thrusters 1631 1634;
   the third and fourth thrusters 1633 1634 are configured to provide a first side roll 1653 1654 of the linear thruster aircraft 1600, when a third increased differential thrust is applied to the third and fourth thrusters 1633 1634;
   the first and second thrusters 1631 1632 are configured to provide a second side roll 1654 1653 of the linear thruster aircraft 1600, when a fourth increased differential thrust is applied to the first and second thrusters 1631 1632;
   the second and fourth thrusters 1632 1634 are configured to provide a first side yaw 1655 1656 of the linear thruster aircraft, when a fifth increased differential thrust is applied to second and fourth thrusters 1632 1634; and
   the first and third thrusters 1631 1633 are configured to provide a second side yaw 1656 1655 of the linear thruster aircraft 1600, when a sixth increased differential thrust is applied to the first and third thrusters 1631 1633.

Thus, in related embodiments, a linear thruster aircraft 100 200 1600 can be configured such that:
a) the first and second thrusters 131 132 comprise at least one first rightward thruster 112 configured to provide a first sideward/rightward downward thrust 172 with respect to the elongated axis 141 1644, and at least one first leftward thruster 112 configured to provide a second sideward/leftward downward thrust 174 with respect to the elongated axis 141 1644; and
b) the third and second thrusters comprise at least one second rightward thruster 112 configured to provide a first sideward/rightward downward thrust 172 141 1644, and at least one second leftward thruster configured to provide a second sideward/leftward downward thrust 174;
whereby the at least one linear thruster arrangement 110 210 1610 is configured to provide lift 160, pitch 151 152, roll 152 153, and yaw 155 156 for the linear thruster aircraft 100 200 1600. In some related embodiments, yaw can be provided solely by increased rotational torque from a horizontal outer thruster (i.e. neither rightward/frontward or leftward/rearward oriented).

In a related embodiment, as shown in FIGS. 7 and 9 the linear thruster aircraft 700 900 can further include a second linear thruster arrangement, wherein the second linear thruster arrangement is mounted below the first linear thruster arrangement.

In a related embodiment, as shown in FIGS. 11, 14 and 15 the linear thruster aircraft 1100 1400 1500 can further include a second linear thruster arrangement, wherein the second linear thruster arrangement is mounted to a side of the first linear thruster arrangement.

In various related embodiments, as shown in FIG. 9B, a linear thruster aircraft 950, can include a linear thruster arrangement 960 with more than four thrusters 112, such as for example eight or more thrusters 112, which can be configured with alternating first sideward/rightward and second sideward/leftward downward thrust.

In a related embodiment, as shown in FIGS. 2 and 17, the linear thruster aircraft 200 1700 can further include an aircraft control unit 242, which is mounted in the aircraft body 240, for example in a main body 124, wherein the aircraft control unit 242 is configured to control a specific power applied for each thruster 112 in the linear thruster arrangement 210.

In a further related embodiment, as shown in FIGS. 2 and 17, the linear thruster aircraft 200 1700 can be configured to communicate, via the aircraft control unit 242, with a remote control device 290, such that a user 1720 can use the remote control device 290 to control the linear thruster aircraft 1700.

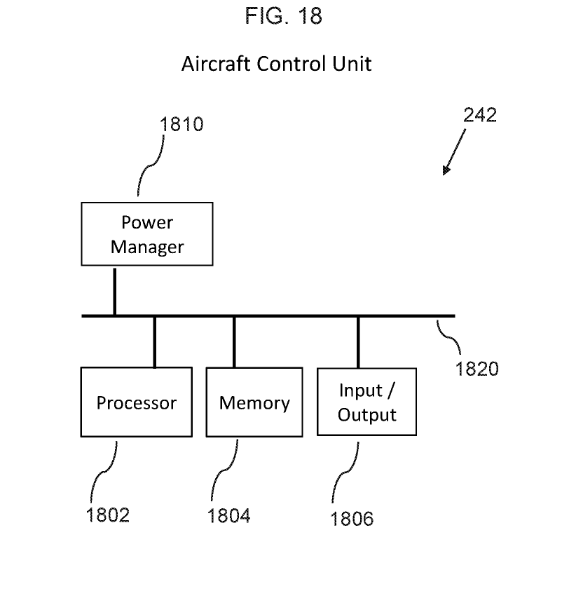

In a related embodiment, as shown in FIG. 18 the aircraft control unit 242 can further include:
a) a processor 1802;
b) a non-transitory memory 1804;
c) an input/output component 1806; and
d) a power manager 1810 (that can also be referred to as a flight manager 1810), which is configured to control the specific power applied for each thruster 112 in the first linear thruster arrangement 110; all connected via
e) a data bus 1820.

In related embodiments, the flight manager 1820 can execute flight control software that is loaded into memory 1804, and the aircraft control unit 242 can further include (or communicate with) flight control/avionic systems/components such as accelerometers, gyros, barometer, GPS, etc.

In an embodiment, as shown in FIGS. 1, 2, 9A, 5A, 5B, 7, 9A, 11, 13, 14, and 15, a linear thruster aircraft 100 200 500 700 900 1100 1400 1500 1600, can include:
b) a linear thruster arrangement, comprising
   a first plurality of at least two thrusters 131 132, which are positioned to a front/first side of a center of mass 190 of the linear thruster aircraft 100, with respect to a perpendicular plane 170 of the center of mass, which perpendicular plane 170 is perpendicular to an elongated axis 144 1644 of the linear thruster aircraft; and
   a second plurality of at least two thrusters 133 134, which are positioned to a rear/second (i.e. opposite) side of the center of mass 190 of the linear thruster aircraft, with respect to the perpendicular plane 170 of the center mass;
wherein each thruster 112 of the at least one linear thruster arrangement is positioned along an elongated axis 142 1644 of the linear thruster aircraft 100;
wherein the first plurality comprises at least one thruster configured to provide a right/rear/first sideward downward thrust 172 1672 and at least one thruster configured to provide a left/front/opposite second sideward downward thrust 174 1674; and
wherein the second plurality comprises at least one thruster configured to provide a right/rear/first sideward downward thrust 172 1672 and at least one thruster configured to provide a left/front/opposite second downward thrust 174 1674.

In a related embodiment, the first plurality can include first and second thrusters 131 132, and the second plurality can include third and fourth thrusters 133 134;

wherein the first and fourth thrusters 131 134 are configured with a first sideward downward thrust 172 1672 with respect to the elongated axis 142 1644, and the second and third thrusters 132 133 are configured with a second sideward downward thrust 174 1672 with respect to the elongated axis 142 1644.

In an embodiment, as shown in FIG. 5B, a linear thruster aircraft 500, can include:
a) a linear thruster arrangement, comprising
   a first thruster 411; and
   a second thruster 412;
   a third thruster 413; and
   a fourth thruster 414;
wherein the thrusters are located either above or below the center of mass 190 of the aircraft;
wherein each thruster of the first linear thruster arrangement is positioned substantially along an elongated axis 542 of the linear thruster aircraft;
such that the first, second, third, and fourth thrusters are configured with alternating first/right/left 502 504 and second/left/right side lateral offsets 504 502 from the elongated axis.

FIGS. 17 and 18 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 17 and 18 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

It shall be understood that the above-mentioned components of the aircraft control unit 242 are to be interpreted in the most general manner.

For example, the processor 1802 can include a single physical microprocessor or microcontroller, a cluster of processors, a datacenter or a cluster of datacenters, a computing cloud service, and the like.

In a further example, the non-transitory memory 1804 can include various forms of non-transitory storage media, including random access memory and other forms of dynamic storage, and hard disks, hard disk clusters, cloud storage services, and other forms of long-term storage. Similarly, the input/output 1806 can include a plurality of well-known input/output devices, such as screens, keyboards, pointing devices, motion trackers, communication ports, and so forth.

Furthermore, it shall be understood that the aircraft control unit 242 can include a number of other components that are well known in the art of general computer devices, and therefore shall not be further described herein. This can include system access to common functions and hardware, such as for example via operating system layers such as WINDOWS™, LINUX™, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the linear thruster aircraft 100 device, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A linear thruster aircraft, comprising:
a) at least one linear thruster arrangement, comprising:
a first thruster;
a second thruster;
a third thruster; and
a fourth thruster; and
b) an aircraft body;
wherein each thruster of the at least one linear thruster arrangement is connected to the aircraft body along an elongated axis of the aircraft body;
wherein the at least one linear thruster arrangement is vertically displaced from a center of mass of the linear thruster aircraft;
wherein the first and second thrusters are positioned on a first side of the center of mass of the linear thruster aircraft;
wherein the third and fourth thrusters are positioned on a second side of the center of mass of the linear thruster aircraft.

2. The linear thruster aircraft of claim 1, wherein:
a) the first and second thrusters comprise at least one thruster configured to provide a first sideward downward thrust with respect to the elongated axis and at least one thruster configured to provide a second sideward downward thrust with respect to the elongated axis; and
b) the third and second thrusters comprise at least one thruster configured to provide a first sideward downward thrust with respect to the elongated axis and at least one thruster configured to provide a second sideward downward thrust with respect to the elongated axis;
whereby the at least one linear thruster arrangement is configured to provide lift, pitch, roll, and yaw for the linear thruster aircraft.

3. The linear thruster aircraft of claim 1, wherein each thruster of the at least one linear thruster arrangement is mounted along a longitudinal axis of the aircraft body.

4. The linear thruster aircraft of claim 1, wherein each thruster of the at least one linear thruster arrangement is mounted along a lateral axis of the aircraft body.

5. The linear thruster aircraft of claim 1, wherein each thruster of the at least one linear thruster arrangement is a rotor.

6. The linear thruster aircraft of claim 1, wherein the at least one linear thruster arrangement is positioned above a center of mass of the linear thruster aircraft, such that the at least one linear thruster arrangement lifts the linear thruster aircraft from a top of the linear thruster aircraft.

7. The linear thruster aircraft of claim 1, wherein the at least one linear thruster arrangement is positioned below a center of mass of the linear thruster aircraft, such that the linear thruster arrangement lifts the linear thruster aircraft from a bottom of the linear thruster aircraft.

8. The linear thruster aircraft of claim 1, further comprising a plurality of rotor shrouds, wherein each thruster of the at least one linear thruster arrangement is configured to spin inside a rotor shroud.

9. The linear thruster aircraft of claim 3, wherein the at least one linear thruster arrangement is positioned above the center of mass of the linear thruster aircraft; and wherein the first and fourth thrusters are configured with a rightward downward thrust with respect to the longitudinal axis, and the second and third thrusters are configured with a leftward downward thrust with respect to the longitudinal axis; such that:
the first and second thrusters are configured to provide a positive pitch of the linear thruster aircraft, when a first increased differential thrust is applied to the first and second thrusters;
the third and fourth thrusters are configured to provide a negative pitch of the linear thruster aircraft, when a second increased differential thrust is applied to the third and fourth thrusters;
the second and third thrusters are configured to provide a right roll of the linear thruster aircraft, when a third increased differential thrust is applied to the second and third thrusters;
the first and fourth thrusters are configured to provide a left roll of the linear thruster aircraft, when a fourth increased differential thrust is applied to the first and fourth thrusters;
the second and fourth thrusters are configured to provide a right side yaw of the linear thruster aircraft, when a fifth increased differential thrust is applied to the second and fourth thrusters; and
the first and third thrusters are configured to provide a left side yaw of the linear thruster aircraft, when a sixth increased differential thrust is applied to the first and third thrusters.

10. The linear thruster aircraft of claim 3, wherein the at least one linear thruster arrangement is positioned above the center of mass of the linear thruster aircraft; and wherein the first and fourth thrusters are configured with a first sideward downward thrust with respect to the longitudinal axis, and the second and third thrusters are configured with a second sideward downward thrust with respect to the longitudinal axis; such that:
the first and second thrusters are configured to provide a positive pitch of the linear thruster aircraft, when a first increased differential thrust is applied to the first and second thrusters;
the third and fourth thrusters are configured to provide a negative pitch of the linear thruster aircraft, when a second increased differential thrust is applied to the third and fourth thrusters;
the second and third thrusters are configured to provide a first side roll of the linear thruster aircraft, when a third increased differential thrust is applied to the second and third thrusters;
the first and fourth thrusters are configured to provide a second side roll of the linear thruster aircraft, when a fourth increased differential thrust is applied to the first and fourth thrusters;
the second and fourth thrusters are configured to provide a first side yaw of the linear thruster aircraft, when a fifth increased differential thrust is applied to the second and fourth thrusters; and
the first and third thrusters are configured to provide a second side yaw of the linear thruster aircraft, when a sixth increased differential thrust is applied to the first and third thrusters.

11. The linear thruster aircraft of claim 3, wherein the at least one linear thruster arrangement is positioned below the center of mass of the linear thruster aircraft; and wherein the first and fourth thrusters are configured with a first sideward downward thrust with respect to the longitudinal axis, and the second and third thrusters are configured with a second sideward downward thrust with respect to the longitudinal axis; such that:
the first and second thrusters are configured to provide a positive pitch of the linear thruster aircraft, when a first increased differential thrust is applied to the first and second thrusters;
the third and fourth thrusters are configured to provide a negative pitch of the linear thruster aircraft, when a second increased differential thrust is applied to the third and fourth thrusters;
the first and fourth thrusters are configured to provide a first side roll of the linear thruster aircraft, when a third increased differential thrust is applied to the first and fourth thrusters;
the second and third thrusters are configured to provide a second side roll of the linear thruster aircraft, when a fourth increased differential thrust is applied to the second and third thrusters;
the second and fourth thrusters are configured to provide a first side yaw of the linear thruster aircraft, when a fifth increased differential thrust is applied to the second and fourth thrusters; and
the first and third thrusters are configured to provide a second side yaw of the linear thruster aircraft, when a sixth increased differential thrust is applied to the first and third thrusters.

12. The linear thruster aircraft of claim 10, wherein the first and fourth thrusters are configured with a leftward tilt, and the second and third thrusters are configured with a rightward tilt.

13. The linear thruster aircraft of claim 10, further comprising a plurality of control vanes, wherein the first and fourth thrusters are configured with leftward oriented control vanes, and the second and third thrusters are configured with rightward oriented control vanes.

14. The linear thruster aircraft of claim 4, wherein the at least one linear thruster arrangement is positioned above the center of mass of the linear thruster aircraft; wherein the first and fourth thrusters are configured with a rearward downward thrust, and the second and third thrusters are configured with a forward downward thrust; such that:
the second and third thrusters are configured to provide a positive pitch of the linear thruster aircraft, when a first increased differential thrust is applied to the second and third thrusters;
the first and fourth thrusters are configured to provide a negative pitch of the linear thruster aircraft, when a second increased differential thrust is applied to the first and fourth thrusters;
the third and fourth thrusters are configured to provide a right roll of the linear thruster aircraft, when a third increased differential thrust is applied to the third and fourth thrusters;
the first and second thrusters are configured to provide a left roll of the linear thruster aircraft, when a fourth increased differential thrust is applied to the first and second thrusters;
the second and fourth thrusters are configured to provide a right yaw of the linear thruster aircraft, when a fifth increased differential thrust is applied to second and fourth thrusters; and
the first and third thrusters are configured to provide a left yaw of the linear thruster aircraft, when a sixth increased differential thrust is applied to the first and third thrusters.

15. The linear thruster aircraft of claim 4, wherein the at least one linear thruster arrangement is positioned above the center of mass of the linear thruster aircraft; wherein the first and fourth thrusters are configured with a first side downward thrust with respect to the lateral axis, and the second and third thrusters are configured with a second side downward thrust with respect to the lateral axis; such that:
the second and third thrusters are configured to provide a first vertical direction pitch of the linear thruster aircraft, when a first increased differential thrust is applied to the second and third thrusters;
the first and fourth thrusters are configured to provide a second vertical direction pitch of the linear thruster aircraft, when a second increased differential thrust is applied to the first and fourth thrusters;
the third and fourth thrusters are configured to provide a first side roll of the linear thruster aircraft, when a third increased differential thrust is applied to the third and fourth thrusters;
the first and second thrusters are configured to provide a second side roll of the linear thruster aircraft, when a fourth increased differential thrust is applied to the first and second thrusters;
the second and fourth thrusters are configured to provide a first side yaw of the linear thruster aircraft, when a fifth increased differential thrust is applied to second and fourth thrusters; and
the first and third thrusters are configured to provide a second yaw of the linear thruster aircraft, when a sixth increased differential thrust is applied to the first and third thrusters.

16. The linear thruster aircraft of claim 1, further comprising a second linear thruster arrangement, wherein the second linear thruster arrangement is mounted below the at least one linear thruster arrangement.

17. The linear thruster aircraft of claim 1, further comprising a second linear thruster arrangement, wherein the second linear thruster arrangement is mounted to a side of the at least one linear thruster arrangement.

18. The linear thruster aircraft of claim 1, further comprising an aircraft control unit, which is mounted in the aircraft body, wherein the aircraft control unit is configured to control a specific power applied for each thruster in the at least one linear thruster arrangement.

19. The linear thruster aircraft of claim 18, wherein the aircraft control unit further comprises:
a) a processor;
b) a non-transitory memory;
c) an input/output component; and
d) a power manager, which is configured to control the specific power applied for each thruster in the at least one linear thruster arrangement; all connected via
e) a data bus.

20. A linear thruster aircraft, comprising:
at least one linear thruster arrangement, comprising:
a first plurality of at least two thrusters, which are positioned to a first side of a center of mass of the linear thruster aircraft; and
a second plurality of at least two thrusters, which are positioned to a second side of the center of mass of the linear thruster aircraft;
wherein the first plurality comprises at least one thruster configured to provide a first sideward downward thrust and at least one thruster configured to provide a second sideward downward thrust; and
wherein the second plurality comprises at least one thruster configured to provide a first sideward downward thrust and at least one thruster configured to provide a second sideward downward thrust.

21. The linear thruster aircraft of claim 20, wherein each thruster of the at least one linear thruster arrangement is positioned along an elongated axis of the linear thruster aircraft.

22. The linear thruster aircraft of claim 21, wherein the first plurality comprises first and second thrusters, and the second plurality comprises third and fourth thrusters;
wherein the first and fourth thrusters are configured with a first sideward downward thrust with respect to the elongated axis, and the second and third thrusters are configured with a second sideward downward thrust with respect to the elongated axis.

23. The linear thruster aircraft of claim 20, wherein the at least one linear thruster arrangement comprises a first linear thruster arrangement and a second linear thruster arrangement.

24. A linear thruster aircraft, comprising:
at least one linear thruster arrangement, comprising:
a first thruster;
a second thruster;
a third thruster; and
a fourth thruster;
wherein each thruster of the at least one linear thruster arrangement is positioned substantially along an elongated axis of the linear thruster aircraft; such that the first, second, third, and fourth thrusters are configured with alternating first and second side lateral offsets from the elongated axis.

25. The linear thruster aircraft of claim 24, wherein each thruster of the at least one linear thruster arrangement is mounted along a longitudinal axis of the aircraft body.

26. The linear thruster aircraft of claim 24, wherein each thruster of the at least one linear thruster arrangement is mounted along a lateral axis of the aircraft body.

27. The linear thruster aircraft of claim 24, wherein the first and fourth thrusters are configured with a first sideward downward thrust with respect to the elongated axis; and the second and third thrusters are configured with a second sideward downward thrust with respect to the elongated axis.
